(19) United States
(12) Patent Application Publication
(10) Pub. No.: US 2026/0052338 A1
(43) Pub. Date: Feb. 19, 2026

(54) LOUDSPEAKER AND ELECTRONIC DEVICE

(71) Applicant: MERRY ELECTRONICS (SUZHOU) CO., LTD., Suzhou City (CN)

(72) Inventors: Chunlong ZHENG, Suzhou City (CN); Mingya LUO, Suzhou City (CN)

(73) Assignee: MERRY ELECTRONICS (SUZHOU) CO., LTD., Suzhou City (CN)

(21) Appl. No.: 18/928,458

(22) Filed: Oct. 28, 2024

(30) Foreign Application Priority Data
Aug. 19, 2024 (CN) 202411133459.9

(51) Int. Cl. H04R 1/28; H04R 7/04; H04R 7/18

(52) U.S. Cl. CPC H04R 1/2811; H04R 7/04; H04R 7/18; H04R 2400/11

(57) ABSTRACT

The present disclosure belongs to the field of loudspeakers and discloses a loudspeaker and an electronic device. The loudspeaker includes a support, a diaphragm assembly, and a vibration assembly; where a cavity extending through the upper surface and the lower surface of the support is formed on the support; the vibration assembly is disposed on a side, facing the vibration assembly, of the diaphragm assembly and is capable of driving the diaphragm assembly to vibrate in a third direction; the vibration assembly includes multiple sound-producing structures, and the multiple sound-producing structures are disposed in the same layer on the support.

### CROSS-REFERENCE TO RELATED APPLICATION(S)

This application claims priority to Chinese Patent Application No. 202411133459.9 filed Aug. 19, 2024, the disclosure of which is incorporated herein by reference in its entirety.

### TECHNICAL FIELD

The present disclosure relates to the field of loudspeakers and, in particular, to a loudspeaker and an electronic device.

### BACKGROUND

A loudspeaker, as an important electro-acoustic device, has been widely used in an electronic device. The loudspeaker can be divided into a moving-coil loudspeaker, a moving-iron loudspeaker, and a piezoelectric loudspeaker according to the type of technology. The piezoelectric loudspeaker has the advantages of being small, thin, lightweight, and free of magnetic field interference compared to the moving-coil loudspeaker.

In the related art, the piezoelectric loudspeaker includes a piezoelectric plate and a diaphragm stacked with the piezoelectric plate. The piezoelectric plate vibrates under a drive voltage to drive the diaphragm to vibrate, thereby enabling the loudspeaker to produce sound. One end of the piezoelectric plate is fixed to form a cantilever structure, and the other end of the piezoelectric plate is deformed upward or downward. Moreover, generally, only one piezoelectric plate is disposed. As a result, the area of the piezoelectric plate is small, and the sensitivity is thus low. Under the condition of a limited size, the length of the piezoelectric plate is short, and the low-frequency performance of the loudspeaker is thus poor, thereby affecting the acoustic performance of the loudspeaker.

Therefore, a loudspeaker having high sensitivity is urgently needed.

### SUMMARY

The present disclosure provides a loudspeaker.

The loudspeaker includes a support, a diaphragm assembly, and a vibration assembly.

The support is provided with a cavity extending through the upper surface of the support and the lower surface of the support.

The periphery of the diaphragm assembly is fixedly connected to the support.

The vibration assembly is disposed on a side of the diaphragm assembly facing the support, and is capable of driving the diaphragm assembly to vibrate in a third direction. The vibration assembly includes multiple sound-producing structures, and the multiple sound-producing structures are disposed in the same layer on the support.

The multiple sound-producing structures include a first sound-producing structure and a second sound-producing structure. The first sound-producing structure includes a first free end and a first fixed end which are opposite to each other in a first direction. The first fixed end is connected to one end of the support, and the first free end is disposed on a side of the diaphragm assembly facing the cavity and is fixedly connected to the diaphragm assembly. The second sound-producing structure includes a second free end and a second fixed end which are opposite to each other in the first direction. The second fixed end is connected to the other end of the support, and the second free end is disposed on the side of the diaphragm assembly facing the cavity and is fixedly connected to the diaphragm assembly. The first direction is perpendicular to the third direction herein.

In some embodiments, the first sound-producing structure and the second sound-producing structure have a gap therebetween. The orthographic projection of the first sound-producing structure in a second direction and the orthographic projection of the second sound-producing structure in the second direction have an overlapping portion. Any two of the first direction, the second direction or the third direction are perpendicular to each other herein.

In some embodiments, the first free end and the second free end are alternately disposed in the second direction.

In some embodiments, multiple first sound-producing structures and multiple second sound-producing structures are disposed in the loudspeaker, and at least two second free ends of at least two second sound-producing structures among the plurality of second sound-producing structures are disposed between two adjacent first free ends of two adjacent first sound-producing structures among the plurality of first sound-producing structures in the second direction.

In some embodiments, multiple first sound-producing structures and multiple second sound-producing structures are disposed in the loudspeaker, and at least two first free ends of at least two first sound-producing structures among the plurality of first sound-producing structures are disposed between two adjacent second free ends of two adjacent second sound-producing structures among the plurality of second sound-producing structures in the second direction.

In some embodiments, the vibration direction of the first sound-producing structure in the third direction is the same as the vibration direction of the second sound-producing structure in the third direction.

In some embodiments, the first free end and the second free end are each provided with a transmission member. The transmission member of the first free end is disposed on a side of the first sound-producing structure facing away from the cavity, and a side of the transmission member of the first free end, facing away from the first free end, is connected to the diaphragm assembly. The transmission member of the second free end is disposed on a side of the second sound-producing structure facing away from the cavity, and a side of the transmission member of the second free end, facing away from the second free end, is connected to the diaphragm assembly.

In some embodiments, two vibration assemblies are disposed. The sound-producing structure of one of the two vibration assemblies is connected to the top surface of the support, and a portion of the sound-producing structure of the one of the two vibration assemblies is disposed above the cavity. The sound-producing structure of the other one of the two vibration assemblies is connected to the bottom surface of the support, and a portion of the sound-producing structure of the other one of the two vibration assemblies is disposed below the cavity.

In some embodiments, two diaphragm assemblies are disposed in the loudspeaker. The two diaphragm assemblies are in a one-to-one correspondence with the two vibration assemblies. Each of the two diaphragm assemblies is disposed on a side, facing away from the support, of a respective one of the two vibration assemblies.

In some embodiments, an orthographic projection of a sound-producing structure of one of the two vibration assemblies on the plane where the support is located fully overlaps an orthographic projection of a sound-producing structure of the other one of the two vibration assemblies on the plane where the support.

In some embodiments, an orthographic projection of a sound-producing structure of one of the two vibration assemblies on the plane where the support is located does not fully overlap an orthographic projection of a sound-producing structure of the other one of the two vibration assemblies on the plane where the support is located.

In some embodiments, a length of a first sound-producing structure of one of the two vibration assemblies in the first direction is different from a length of a first sound-producing structure of the other one of the two vibration assemblies in the first direction, and a length of a second sound-producing structure of one of the two vibration assemblies in the first direction is different from a length of a second sound-producing structure of the other one of the two vibration assemblies in the first direction.

In some embodiments, a vibration direction of a first sound-producing structure of one of the two vibration assemblies in the third direction is opposite to a vibration direction of a first sound-producing structure of the other one of the two vibration assemblies in the third direction, a vibration direction of a second sound-producing structure of one of the two vibration assemblies in the third direction is opposite to a vibration direction of a second sound-producing structure of the other one of the two vibration assemblies in the third direction, and the third direction is perpendicular to the first direction.

In some embodiments, the multiple sound-producing structures all have the same cross-sectional shape; and/or, a sound-producing structure of the multiple sound-producing structures has a rectangular, trapezoidal or triangular cross-section.

The present disclosure further provides an electronic device.

The electronic device includes the loudspeaker described above.

### BRIEF DESCRIPTION OF DRAWINGS

To illustrate the solutions in embodiments of the present disclosure more clearly, the drawings used in the description of the embodiments of the present disclosure are briefly described below. Apparently, the drawings described below illustrate only part of the embodiments of the present disclosure, and those of ordinary skill in the art may obtain other drawings based on the embodiments of the present disclosure and the drawings on the premise that no creative work is done.

FIG. 1 is a structure view one of a loudspeaker provided by one or more embodiments of the present disclosure;

FIG. 2 is a structure view two of the loudspeaker provided by one or more embodiments of the present disclosure;

FIG. 3 is an exploded view of the loudspeaker provided by one or more embodiments of the present disclosure;

FIG. 4 is a structure view of a support and a vibration assembly provided by one or more embodiments of the present disclosure;

FIG. 5 is a top view of the support and the vibration assembly provided by one or more embodiments of the present disclosure;

FIG. 6 is a cross-section view of the loudspeaker provided by one or more embodiments of the present disclosure;

FIG. 7 is a structure view of a loudspeaker provided by one or more embodiments of the present disclosure;

FIG. 8 is a structure view of a support and a vibration assembly provided by one or more embodiments of the present disclosure;

FIG. 9 is a top view of the support and the vibration assembly provided by one or more embodiments of the present disclosure; and

FIG. 10 is a cross-section view of the loudspeaker provided by one or more embodiments of the present disclosure.

### REFERENCE LIST

100 support
110 upper surface
120 lower surface
130 cavity
200 vibration assembly
210 first sound-producing structure
21: first free end
212 first fixed end
220 second sound-producing structure
221 second free end
222 second fixed end
230 transmission member
300 diaphragm assembly
310 diaphragm
320 dome
400 upper housing
500 upper fixed frame
600 lower fixed frame
700 lower housing
810 front acoustic hole
820 rear acoustic hole
X first direction
Y second direction
Z third direction

### DETAILED DESCRIPTION

To make the problems to be solved, the solutions to be adopted and the effects to be achieved by the present disclosure clearer, the solutions of the present disclosure are further described below through embodiments in conjunction with drawings. It is to be understood that the embodiments described herein are intended to explain the present disclosure and not to limit the present disclosure. In addition, it is to be noted that for ease of description, only a part, not all, related to the present disclosure is illustrated in the drawings.

It is to be noted that similar reference numerals and letters indicate similar items in the following drawings. Therefore, once a certain item is defined in one drawing, the similar reference numeral or letter does not need to be defined or explained in the subsequent drawings.

To make the problems to be solved, the solutions to be adopted and the effects to be achieved by the present disclosure clearer, the solutions of the present disclosure are further described below through embodiments in conjunction with drawings. For those of ordinary skill in the art, specific meanings of the preceding terms in the present disclosure may be construed based on specific situations.

In the present disclosure, unless otherwise expressly specified and limited, a first feature being “above” or “below” a second feature may include that the first feature and the second feature may be in direct contact or may include that the first feature and the second feature are in contact via another feature between the two features instead of being in direct contact. Moreover, the first feature being “on”, “above” or “over” the second feature includes that the first feature is right or obliquely above the second feature or simply means that the first feature is at a higher level than the second feature. The first feature being “under”, “below” or “underneath” the second feature includes that the first feature is right or obliquely below the second feature or simply means that the first feature is at a lower level than the second feature. In the description of the embodiments, unless otherwise specified, “a plurality of” or “multiple” means two or more.

In the description of the embodiments, the orientation or position relationships indicated by the terms upper”, “lower”, “right”, and the like are based on the orientation or position relationships shown in the drawings. These orientations or position relations are intended only to facilitate and simplify the description of the present disclosure and not to indicate or imply that a device or element referred to must have such particular orientations or must be configured or operated in such particular orientations. Thus, these orientations or position relations are not to be construed as limiting the present disclosure. In addition, the terms “first” and “second” are merely used for descriptive purposes and have no special meanings.

It is to be noted that when an element is described as being “fixed to” or “disposed on” another element, the element may be directly on the particular element or an intervening element may be on the particular element.

One or more embodiments provide a loudspeaker having high sensitivity and good acoustic performance.

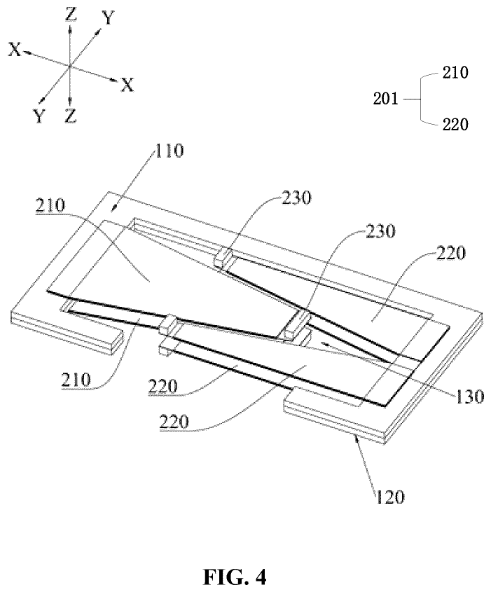

An X, Y, and Z coordinate system may be established in some of the drawings for the convenience of the following description. The plane where the loudspeaker shown in FIG. 5 is located may be the XY plane. With an example where the loudspeaker shown in FIG. 4 is a rectangle, the X-axis is the first direction that may be the length direction of the loudspeaker, the Y-axis is the second direction that may be the width direction of the loudspeaker, and the Z-axis is the third direction that is a direction perpendicular to, or within the manufacturing tolerance approximately perpendicular to, the loudspeaker, for example, the Z-axis is the thickness direction of the loudspeaker. As can be seen, any two of the first direction, the second direction, and the third direction are perpendicular to each other. It is to be understood that the width of the loudspeaker is less than the length of the loudspeaker.

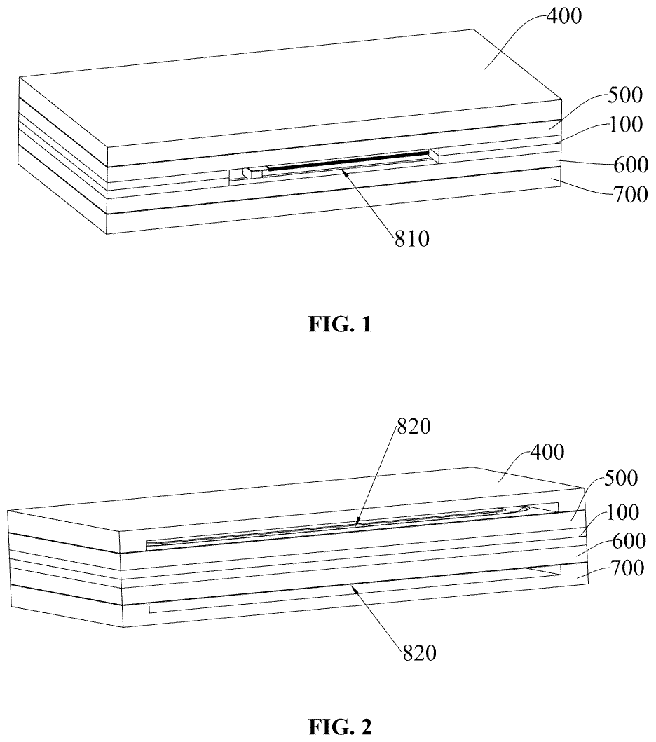

As shown in FIGS. 1 to 6, the loudspeaker includes a support 100, a diaphragm assembly 300, and a vibration assembly 200. The support 100 has an upper surface 110 and a lower surface 120 which are opposite to each other in the third direction Z. A cavity 130 extending through the upper surface 110 and the lower surface 120 is formed on the support 100. The periphery of the diaphragm assembly 300 is fixedly connected to the support 100. The vibration assembly 200 is disposed on a side of the diaphragm assembly 300 facing the support 100. The vibration assembly 200, when vibrating, is capable of driving the diaphragm assembly 300 to vibrate and then produce sound.

It is to be noted that the loudspeaker further includes a circuit board. The vibration assembly 200 is electrically connected to the circuit board, and the circuit board is used for sending acousto-electric signals to the vibration assembly 200 to stimulate the vibration of the vibration assembly 200 to produce sound. The vibration assembly 200 may form a vibration plane and vibrate to produce sound according to the received acoustic-electric signals, thereby achieving the sound-producing function of the loudspeaker.

As shown in FIG. 4, each vibration assembly 200 includes multiple sound-producing structures 201. In some optional embodiments, the multiple sound-producing structures 201 are disposed in the same layer in the support 100, that is, the multiple sound-producing structures 201 of each vibration assembly 200 are located in the same plane to ensure that the distance between each of the multiple sound-producing structures and the diaphragm assembly 300 of the loudspeaker is the same. The multiple sound-producing structures 201 are electrically connected to the circuit board, and the circuit board is used for sending an acoustic-electric signal to each sound-producing structure to stimulate each sound-producing structure to vibrate and produce sound. Optionally, the number of sound-producing structures 201 may be three, four, five, six or the like, which is not limited herein. Preferably, the number of sound-producing structures is an even number.

For example, the sound-producing structure 201 may include a driver and a cantilever. One end of the cantilever is connected to the support 100. The other end of the cantilever extends to become opposite to the cavity 130 in the third direction Z, and the other end of the cantilever is a free end. The driver is connected to the cantilever. The driver may be formed above and/or below the cantilever beam. The area of the driver may be equal to the area of the cantilever or may be less than the area of the cantilever. The driver may drive the cantilever to vibrate in the third direction Z. For example, the driver may be any of a piezoelectric driver, an electrostatic driver, an electromagnetic driver or a thermoelectric driver.

In some optional embodiments, the support 100 may include a circuit board, and a cavity 130 extending through the support 100 is formed on the circuit board. A portion of the sound-producing structure may be directly electrically connected to the circuit board for transmission of acoustic-electric signals. In some other optional embodiments, the support 100 may not include a circuit board and only provides support. In still other optional embodiments, the support 100 may include a support structure for support and a circuit board, the circuit board is disposed on the support structure, and a portion of the sound-producing structure is supported on the support structure and electrically connected to the circuit board. The specific structure of the support 100 may also be designed according to actual requirements, which is not limited herein.

In this embodiment, the multiple sound-producing structures 201 include a first sound-producing structure 210 and a second sound-producing structure 220. It is to be noted that at least one first sound-producing structure 210 and at least one second sound-producing structure 220 are disposed. As shown in FIG. 5, the first sound-producing structure 210 includes a first free end 211 and a first fixed end 212 which are opposite to each other in the first direction X. The first fixed end 212 is connected to one end of the support 100. The first free end 211 is disposed on a side of the diaphragm assembly 300 facing the cavity 130 and is fixedly connected to the diaphragm assembly 300 so that the first free end 211, when vibrating, is capable of driving the diaphragm assembly 300 to vibrate. The second sound-producing structure 220 includes a second free end 221 and a second fixed end 222 which are opposite to each other in the first direction X. The second fixed end 222 is connected to the other end of the support 100. The second free end 221 is disposed on the side of the diaphragm assembly 300 facing the cavity 130 and is fixedly connected to the diaphragm assembly 300 so that the second free end 221, when vibrating, is capable of driving the diaphragm assembly 300 to vibrate. As can be seen, the first sound-producing structure 210 and the second sound-producing structure 220 in one or more embodiments are both in a cantilever structure.

In the loudspeaker provided in this embodiment, a cavity 130 extending through the upper surface 110 and the lower surface 120 of the support 100 is formed on the support 100, the vibration assembly 200 includes multiple sound-producing structures disposed on the support 100 in the same layer, and the multiple sound-producing structures include a first sound-producing structure 210 and a second sound-producing structure 220. The first fixed end 212 of the first sound-producing structure 210 is connected to one end of the support 100 in the first direction X, the second fixed end 222 of the second sound-producing structure 220 is connected to the other end of the support 100 in the first direction X, and the first free end 211 and the second free end 221 are both disposed on a side of the diaphragm assembly 300 facing the cavity 130, and are both connected to the diaphragm assembly 300 to form a bilateral structure. In this manner, the area of the sound-producing structures opposite the diaphragm assembly 300 becomes large, and the area of action between the vibration assembly 200 and the diaphragm assembly 300 is increased, thereby improving the sensitivity of the loudspeaker and improving the acoustic performance of the loudspeaker.

It is to be noted that the loudspeaker in one or more embodiments may be a single-diaphragm loudspeaker or may be a double-diaphragm loudspeaker, and FIGS. 1 to 6 in one or more embodiments illustrate a case where the loudspeaker is a double-diaphragm loudspeaker.

Optionally, the first sound-producing structure 210 and the second sound-producing structure 220 have a gap therebetween, thereby avoiding interference caused when two adjacent sound-producing structures in the same layer become warp and vibrate.

In some optional embodiments, the orthographic projection of the first sound-producing structure 210 in the second direction Y and the orthographic projection of the second sound-producing structure 220 in the second direction Y have an overlapping portion, that is, the first sound-producing structure 210 and the second sound-producing structure 220 can be staggered from each other, so that the lengths of both the first sound-producing structure 210 and the second sound-producing structure 220 can be long to further increase the areas of the first sound-producing structure 210 and the second sound-producing structure 220, thereby improving the sensitivity of the loudspeaker. Moreover, the lengths of the first sound-producing structure 210 and the second sound-producing structure 220 are long so that the first sound-producing structure 210 and the second sound-producing structure 220 exert similar or the same force on the diaphragm assembly 300 to keep the resultant force on the diaphragm assembly 300 perpendicular to the surface, facing the cavity 130, of the diaphragm assembly 300, thereby improving the effect of driving the diaphragm assembly 300. In addition, when the lengths of the first sound-producing structure 210 and the second sound-producing structure 220 are long, the resonance frequency can be reduced, thereby improving the low-frequency sensitivity of the loudspeaker.

For example, the area of the overlapping portion between the orthographic projection of the first sound-producing structure 210 in the second direction Y and the orthographic projection of the second sound-producing structure 220 in the second direction Y is less than the area of the orthographic projection of the first sound-producing structure 210 in the second direction Y and less than the area of the orthographic projection of the second sound-producing structure 220 in the second direction Y.

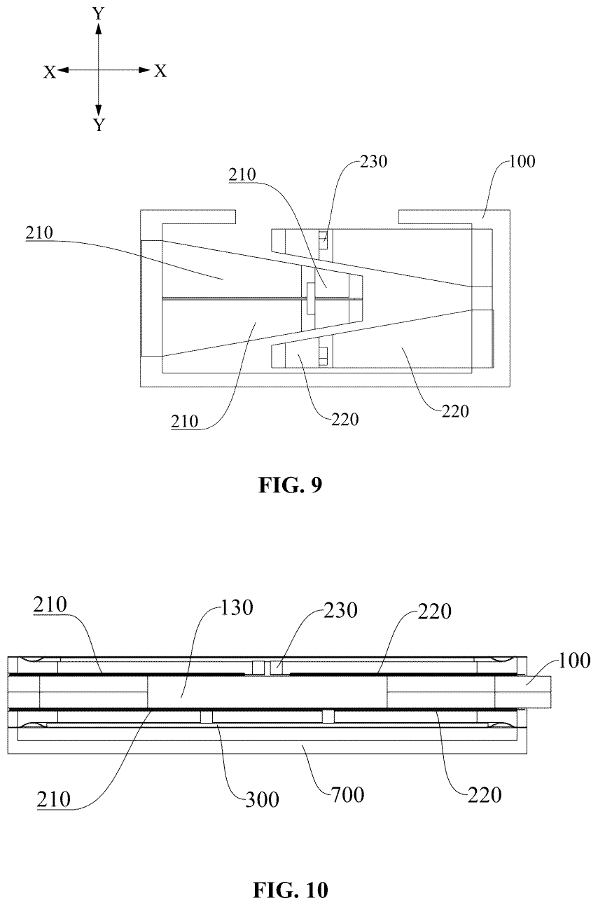

Of course, it is to be understood that, as shown in FIGS. 8 and 9, the orthographic projection of the first sound-producing structure 210 located in the upper layer in the second direction Y and the orthographic projection of the second sound-producing structure 220 in the second direction Y does not have an overlapping portion, that is, the first sound-producing structure 210 and the second sound-producing structure 220 are not staggered, which is not limited herein.

For example, one or more first sound-producing structure 210 and one or more second sound-producing structure 220 may be disposed in the loudspeaker, which is not limited herein.

In this embodiment, as shown in FIG. 5, the first free end 211 and the second free end 221 are alternately disposed in the second direction Y. When one first sound-producing structure 210 and one second sound-producing structure 220 are disposed in the loudspeaker, the first free end 211 of the first sound-producing structure 210 and the second free end 221 of the second sound-producing structure 220 are sequentially arranged in the second direction Y. When two first sound-producing structures 210 and one second sound-producing structure 220 are disposed in the loudspeaker, the second free end 221 of the second sound-producing structure 220 is disposed between two first free ends 211 of the two first sound-producing structures 210. When one first sound-producing structure 210 and two second sound-producing structures 220 are disposed in the loudspeaker, the first free end 211 of the first sound-producing structure 210 is disposed between two second free ends 221 of the two second sound-producing structures 220.

By alternately disposing the first free end 211 and the second free end 221 in the second direction Y, the first sound-producing structure 210 does not affect the extension of the second sound-producing structure 220 in the first direction X, and the second sound-producing structure 220 does not affect the extension of the first sound-producing structure 210 in the first direction X either. In this manner, the lengths of the first sound-producing 210 and the second sound-producing structure 220 in the first direction X can both be long, thereby reducing the resonance frequency and improving the low-frequency sensitivity.

In some other optional embodiments, the first free end 211 and the second free end 221 may not be alternately disposed. For example, multiple first sound-producing structures 210 and multiple second sound-producing structures 220 are disposed in the loudspeaker, and at least two second free ends 221 of at least two second sound-producing structures 220 among multiple second sound-producing structures 220 are disposed between two adjacent first free ends 211 of two adjacent first sound-producing structures 210 among multiple first sound-producing structures 210 in the second direction Y, or, at least two first free ends 211 of at least two first free ends 211 among multiple first sound-producing structures 210 are disposed between two adjacent second free ends 221 of two adjacent second sound-producing structures 220 among multiple second sound-producing structures 220 in the second direction Y. In this manner, the first sound-producing structure 210 and the second sound-producing structure 220 can be prevented from affecting each other in the length direction, thereby reducing the resonance frequency and improving the low-frequency sensitivity. For example, FIG. 8 shows a schematic diagram where two first sound-producing structures 210 are disposed between two adjacent second sound-producing structures 220 in the second direction Y.

Optionally, the vibration direction of the first sound-producing structure 210 of the vibration assembly 200 in the third direction Z is the same as the vibration direction of the second sound-producing structure 220 in the third direction Z to ensure that the driving frequency to the diaphragm assembly 300 can be consistent. It is to be noted that when multiple vibration assemblies 200 are disposed, for the same vibration assembly 200, the vibration direction of the first sound-producing structure 210 in the third direction Z is the same as the vibration direction of the second sound-producing structure 220 in the third direction Z.

In some optional embodiments, as shown in FIG. 2, two vibration assemblies 200 are disposed, and the two vibration assemblies 200 are spaced in the third direction Z. Correspondingly, two diaphragm assemblies 300 are disposed. The two diaphragm assemblies 300 are in a one-to-one correspondence with the two vibration assemblies 200. Each of the two diaphragm assemblies 300 is disposed on a side, facing away from the support 100, of a respective one of the two vibration assemblies 200 so that the two diaphragm assemblies 300 can work normally. By setting two vibration assemblies 200 and enabling the two vibration assemblies 200 to cooperate with the two diaphragm assemblies 300, the two diaphragm assemblies 300 can be driven separately, thereby improving the acoustic performance.

Specifically, the sound-producing structure of one vibration assembly 200 is connected to the top surface of the support 100, and a portion of the sound-producing structure of the one vibration assembly 200 is disposed above the cavity 130; the sound-producing structure of the other vibration assembly 200 is connected to the bottom surface of the support 100, and a portion of the sound-producing structure of the other vibration assembly 200 is disposed below the cavity 130.

Further, optionally, the vibration directions of the first sound-producing structures 210 (or the first free ends 211) of the two vibration assemblies 200 in the third direction Z are opposite to each other, and the vibration directions of the second sound-producing structures 220 (or the second free ends 221) of the two vibration assemblies 200 in the third direction Z are opposite to each other. In this embodiment, the first sound-producing structures 210 (or the first free ends 211) of the two vibration assemblies 200 move face to face or back to back in the third direction Z, and the second sound-producing structures 220 (or the second free ends 221) of the two vibration assemblies 200 move face to face or back to back in the third direction Z. In this manner, the vibrations of the first sound-producing structures 210 (or the first free ends 211) of the two vibration components 200 in the third direction Z can cancel each other out, and the vibrations of the second sound-producing structures 220 (or the second free ends 221) of the two vibration components 200 in the third direction Z can also cancel each other out, so that the loudspeaker as a whole is free of vibration or the vibration is weakened while the diaphragm 310 can be driven to vibrate, thereby achieving the purpose of vibration reduction, reducing the impact of the vibration of the loudspeaker on the electronic device, and improving the user experience.

In some optional embodiments, as shown in FIGS. 4 and 5, the orthographic projections of the sound-producing structures of the two vibration assemblies 200 on a plane where the support 100 is located fully overlap each other, that is, the first sound-producing structures 210 of the two vibration components 200 have the same shape and size, and the second sound-producing structures 220 of the two vibration components 200 have the same shape and size. In this manner, in one aspect, the first sound-producing structure 210 and the second sound-producing structure 220 can be conveniently manufactured in a batch, thereby improving the production efficiency; in another aspect, the vibration-cancelling effect of the first sound-producing structures 210 of the two vibration assemblies 200 can be improved, and the vibration-cancelling effect of the second sound-producing structure 220 of the two vibration assemblies 200 can be improved, thereby reducing the vibration amplitude of the loudspeaker. The plane where the support 100 is located is the XY plane in this embodiment.

For example, the multiple sound-producing structures all have the same cross-sectional shape, that is, the first sound-producing structure 210 and the second sound-producing structure 220 have the same shape and size, thereby further facilitating the manufacturing of the sound-producing structures.

For example, the cross-section of the sound-producing structure is rectangular, trapezoidal, triangular or the like, which is not limited herein. In this embodiment, as shown in FIG. 5, one first sound-producing structure 210 is disposed, and the cross-section of the first sound-producing structure 210 is in the shape of an isosceles trapezoid; two second sound-producing structures 220 are disposed, the first free end 211 of the first sound-producing structure 210 is disposed between the second free ends 221 of the two second sound-producing structures 220 in the second direction Y, and the cross-section of the second sound-producing structures 220 each in the shape of a right-angle trapezoid. In this embodiment, the angle between the leg and the lower base of the first sound-producing structure 210 is equal to the angle between the leg and the lower base of the second sound-producing structure 220 which is not the angle equal to 90° to make the multiple sound-producing structures in a more regular shape, thereby making full use of the planar space above or below the cavity 130.

It is to be noted that the end where the lower base of the first sound-producing structure 210 is located is connected to the support 100, and the end where the lower base of the second sound-producing structure 220 is located is connected to the support 100, thereby improving the strength and reliability of the connection of the first sound-producing structure 210 and the second sound-producing structure 220 with the support 100.

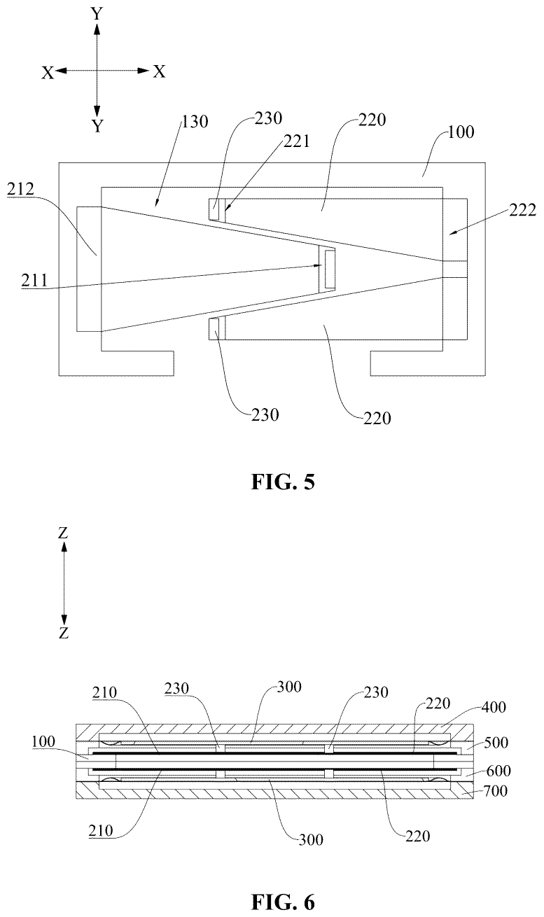

Optionally, as shown in FIG. 5 or 6, the first free end 211 and the second free end 221 are each provided with a transmission member 230. The transmission member 230 of the first free end 211 is disposed on a side of the first sound-producing structure 210 facing the diaphragm assembly 300 corresponding to the first sound-producing structure 210, and transmission member 230 of the second free end 221 is disposed on a side of the second sound-producing structure 220 facing the diaphragm assembly 300 corresponding to the second sound-producing structure 220. A side of the transmission member 230 of the first free end 211, facing away from the first free end 211, is connected to the corresponding diaphragm assembly 300. A side of transmission member 230 of the second free end 221, facing away from the second free end 221, is connected to the corresponding diaphragm assembly 300. As can be seen, in this embodiment, the first free end 211 is connected to the diaphragm assembly 300 through the transmission member 230 of the first free end 211, and the second free end 221 is connected to the diaphragm assembly 300 through the transmission member 230 of the second free end 221. In this manner, the first free end 211 and the second free end 221 can perform transmission with the diaphragm assembly 300 through the transmission member 230, and the transmission member 230 can support the first free end 211 and the second free end 221, thereby improving the stability of the vibration assembly 200.

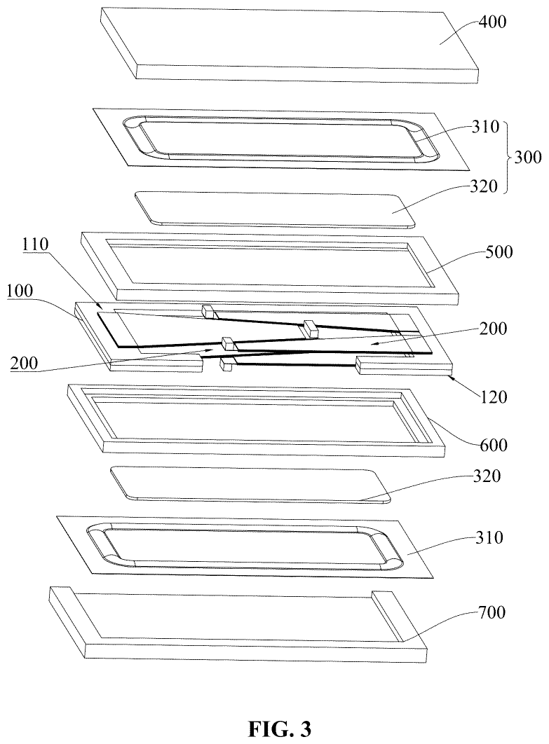

In some optional embodiments, as shown in FIG. 3, the diaphragm assembly 300 includes a diaphragm 310 and a dome 320. The periphery of the diaphragm 310 is fixedly connected between the support 100 and the upper fixed frame 500 or the lower fixed frame 600 of the loudspeaker. The dome 320 is fixedly disposed on a side of the diaphragm 310 facing the vibration assembly 200. The transmission member 230 is connected to the corresponding dome 320.

In some optional embodiments, the loudspeaker further includes a housing, and the housing is connected to the support 100. As shown in FIGS. 1 and 2, the housing is provided with a front acoustic hole 810 and a rear acoustic hole 820, and the vibrating diaphragm assembly 300 is connected to the housing and divides the internal space of the housing into a front acoustic cavity and a rear acoustic cavity. The front acoustic hole 810 is in communication with the front acoustic cavity, and the rear acoustic hole 820 is in communication with the rear acoustic cavity. In this embodiment, the front acoustic cavity and the front acoustic hole 810 are both in communication with the cavity 130. When two diaphragm assemblies 300 are disposed, the front acoustic cavities of the two diaphragm assemblies 300 are in communication with the cavity 130 and share a front acoustic hole 810. For example, the front acoustic hole 810 is opened on the support 100. The rear acoustic cavities of the two diaphragm assemblies 300 are independent of each other and each correspond to a rear acoustic hole 820.

For example, as shown in FIGS. 1 and 2, the housing further includes an upper housing 400, an upper fixed frame 500, a lower fixed frame 600, and a lower housing 700. The upper housing 400, the upper fixed frame 500, the support 100, the lower fixed frame 600, and the lower housing 700 are sequentially connected in the third direction Z. The two diaphragm assemblies 300 are disposed on the upper fixed frame 500 and the lower fixed frame 600, respectively, and for two rear acoustic holes 820, one rear acoustic hole 820 is enclosed by the upper fixed frame 500 and the upper housing 400, and the other rear acoustic hole 820 is enclosed by the lower fixed frame 600 and the lower housing 700.

The circuit board sends acoustic-electric signals to the sound-producing structures of the two vibration assemblies 200 to drive the sound-producing structures to vibrate. The vibration of the sound-producing structures can push the air within the cavity 130 to the outside through the front acoustic holes 810 or make the air outside of the housing enter the cavity 130 through the front sound holes 810. The sound-producing structures also drive the diaphragm assemblies 300 to vibrate to compress the air in the front acoustic cavity and the rear acoustic cavity and produce sound, thereby achieving the function of sound production by vibration.

The beneficial effects of the present disclosure are as follows.

In the loudspeaker and the electronic device provided by the present disclosure, a cavity extending through the upper surface and the lower surface of the support is formed on the support, the vibration assembly includes multiple sound-producing structures disposed on the support in the same layer, and the multiple sound-producing structures include a first sound-producing structure and a second sound-producing structure. A portion of the first sound-producing structure is connected to one end of the support in the first direction, a portion of the second sound-producing structure is connected to the other end of the support in the first direction, and the remaining portions of both the first sound-producing structure and the second sound-producing structure are disposed opposite the cavity to form a bilateral structure. In this manner, the area of the sound-producing structures opposite the cavity becomes large, and the area of action between the vibration assembly and the diaphragm assembly of the loudspeaker is increased, thereby improving the sensitivity of the loudspeaker and improving the acoustic performance of the loudspeaker and the electronic device.

The differences between the following embodiments and preceding embodiments lie in the specific structures of the two vibration assemblies 200.

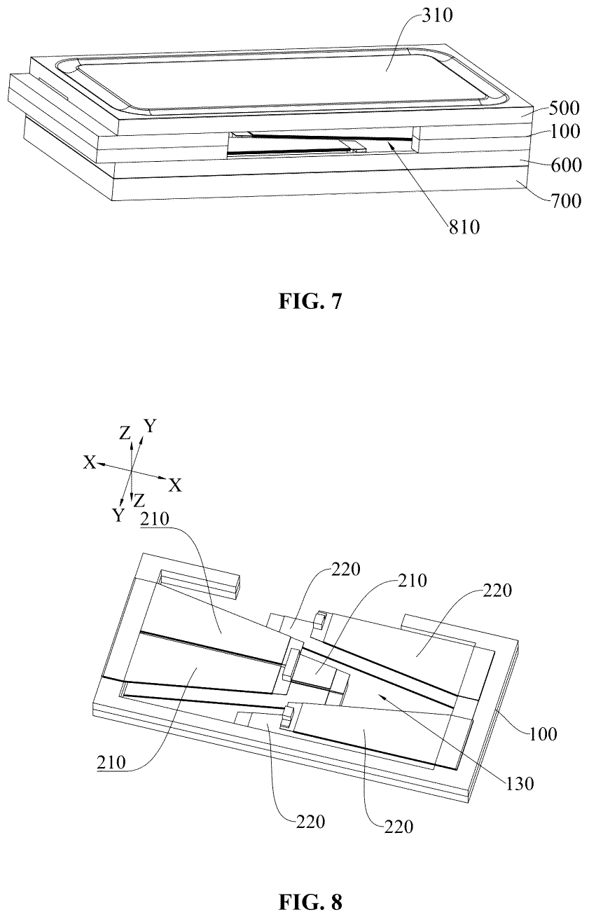

Specifically, as shown in FIGS. 7 to 10, the orthographic projections of the sound-producing structures of the two vibration assemblies 200 on the plane where the support 100 is located do not fully overlap each other but partially overlap. Since the sound-producing structures of the two vibration assemblies 200 still have overlapping portions, the vibration amplitude of the loudspeaker can be suppressed to a certain extent, thereby reducing the vibration amplitude of the loudspeaker.

When the orthographic projections of the sound-producing structures of the two vibration assemblies 200 on the plane where the support 100 is located do not fully overlap each other, the sound-producing structures of the two vibration assemblies 200 may have different sizes and/or different lengths, which is not limited herein.

Optionally, as shown in FIGS. 8 and 9, the first sound-producing structures 210 of the two vibration assemblies 200 have different lengths in the first direction X so that the orthographic projections of the first sound-producing structures 210 of the two vibration assemblies 200 on the plane where the support 100 is located do not fully overlap each other. By setting the first sound-producing structures 210 of the two vibration assemblies 200 to have different lengths in the first direction X, the vibration frequency points of the first sound-producing structures 210 in different layers are staggered, that is, the resonance frequencies of the first sound-producing structures 210 in different layers are different, so that the overall frequency response curve of the loudspeaker becomes relatively flat, thereby improving the acoustic performance of the loudspeaker.

For example, the orthographic projection of the first sound-producing structure 210 of one of the two vibration assemblies 200 on the plane where the support 100 is located is located within the orthographic projection of the first sound-producing structure 210 of the other one of the two vibration assemblies 200 on the plane where the support 100 is located so that the areas of the cross-sections of the first sound-producing structures 210 of the two vibration assemblies 200 become larger, thereby further improving the sensitivity of the loudspeaker.

Similarly, the second sound-producing structures 220 of the two vibration assemblies 200 have different lengths in the first direction X so that the orthographic projections of the second sound-producing structures 220 of the two vibration assemblies 200 on the plane where the support 100 is located do not fully overlap each other. By setting the second sound-producing structures 220 of the two vibration assemblies 200 to have different lengths in the first direction X, the vibration frequency points of the second sound-producing structures 220 in different layers are staggered, that is, the resonance frequencies of the second sound-producing structures 220 in different layers are different, so that the overall frequency response curve of the loudspeaker becomes relatively flat, thereby improving the acoustic performance of the loudspeaker.

For example, the orthographic projection of the second sound-producing structure 220 of one of the two vibration assemblies 200 on the plane where the support 100 is located is located within the orthographic projection of the second sound-producing structure 220 of the other one of the two vibration assemblies 200 on the plane where the support 100 is located so that the areas of the cross-sections of the second sound-producing structures 220 of the two vibration assemblies 200 become larger, thereby further improving the sensitivity of the loudspeaker.

Other structures in one or more embodiments are similar to the corresponding structures in the preceding embodiments and have similar beneficial effects, and the details will not be repeated herein.

The following one or more embodiments provide an electronic device. The electronic device includes the loudspeaker provided in preceding embodiments. The electronic device provided in one or more embodiments has great sound quality.

The electronic device may include a mobile phone, a tablet personal computer, a laptop, a personal digital assistant (PDA), a camera, a personal computer, a notebook computer, an in-vehicle device, a wearable device, augmented reality (AR) glasses, an AR helmet, virtual reality (VR) glasses, a VR helmet, a fixed-line earpiece (a sound pick-up), a medical auxiliary device (for example, a hearing aid), various headphones (for example, wireless or wired headphones), or other devices equipped with loudspeakers. The embodiments of the present application do not impose any special limitations on the specific form of the electronic device.

It is to be noted that the preceding are only preferred embodiments of the present disclosure and the technical principles used therein. It is to be understood by those skilled in the art that the present disclosure is not limited to the embodiments described herein. Those skilled in the art can make various apparent modifications, adaptations, and substitutions without departing from the scope of the present disclosure. Therefore, while the present disclosure is described in detail through the preceding embodiments, the present disclosure is not limited to the preceding embodiments and may include other equivalent embodiments without departing from the concept of the present disclosure. The scope of the present disclosure is determined by the scope of the appended claims.

What is claimed is:

1. A loudspeaker, comprising
a support, wherein the support is provided with a cavity extending through an upper surface of the support and a lower surface of the support;
a diaphragm assembly, wherein a periphery of the diaphragm assembly is fixedly connected to the support; and
a vibration assembly, wherein the vibration assembly is disposed on a side of the diaphragm assembly facing the support and is capable of driving the diaphragm assembly to vibrate in a third direction;
wherein the vibration assembly comprises a plurality of sound-producing structures, and the plurality of sound-producing structures are disposed in a same layer on the support;
the plurality of sound-producing structures comprise a first sound-producing structure and a second sound-producing structure;
the first sound-producing structure comprises a first free end and a first fixed end which are opposite to each other in a first direction, the first fixed end is connected to one end of the support, and the first free end is disposed on a side of the diaphragm assembly facing the cavity and is fixedly connected to the diaphragm assembly;
the second sound-producing structure comprises a second free end and a second fixed end which are opposite to each other in the first direction, the second fixed end is connected to the other end of the support, and the second free end is disposed on the side of the diaphragm assembly facing the cavity and is fixedly connected to the diaphragm assembly; and
the first direction is perpendicular to the third direction.

2. The loudspeaker according to claim 1, wherein the first sound-producing structure and the second sound-producing structure have a gap therebetween; an orthographic projection of the first sound-producing structure in a second direction and an orthographic projection of the second sound-producing structure in the second direction have an overlapping portion; and
any two of the first direction, the second direction or the third direction are perpendicular to each other.

3. The loudspeaker according to claim 2, wherein the first free end and the second free end are alternately disposed in the second direction; or
a plurality of first sound-producing structures and a plurality of second sound-producing structures are disposed, and at least two second free ends of at least two second sound-producing structures among the plurality of second sound-producing structures are disposed between two adjacent first free ends of two adjacent first sound-producing structures among the plurality of first sound-producing structures in the second direction; or
a plurality of first sound-producing structures and a plurality of second sound-producing structures are disposed, and at least two first free ends of at least two first sound-producing structures among the plurality of first sound-producing structures are disposed between two adjacent second free ends of two adjacent second sound-producing structures among the plurality of second sound-producing structures in the second direction.

4. The loudspeaker according to claim 1, wherein a vibration direction of the first sound-producing structure in the third direction is a same as a vibration direction of the second sound-producing structure in the third direction.

5. The loudspeaker according to claim 1, wherein the first free end and the second free end are each provided with a transmission member;
the transmission member of the first free end is disposed on a side of the first sound-producing structure facing away from the cavity, and a side of the transmission member of the first free end, facing away from the first free end, is connected to the diaphragm assembly;
the transmission member of the second free end is disposed on a side of the second sound-producing structure facing away from the cavity; and a side of the transmission member of the second free end, facing away from the second free end, is connected to the diaphragm assembly.

6. The loudspeaker according to claim 1, wherein two vibration assemblies are disposed;
a sound-producing structure of one of the two vibration assemblies is connected to a top surface of the support, and a portion of the sound-producing structure of the one of the two vibration assemblies is disposed above the cavity; and
a sound-producing structure of the other one of the two vibration assemblies is connected to a bottom surface of the support, and a portion of the sound-producing structure of the other one of the two vibration assemblies is disposed below the cavity.

7. The loudspeaker according to claim 6, wherein two diaphragm assemblies are disposed, the two diaphragm assemblies are in a one-to-one correspondence with the two vibration assemblies, and each of the two diaphragm assemblies is disposed on a side, facing away from the support, of a respective one of the two vibration assemblies.

8. The loudspeaker according to claim 7, wherein an orthographic projection of the sound-producing structure of one of the two vibration assemblies on a plane where the support is located fully overlaps an orthographic projection of the sound-producing structure of the other one of the two vibration assemblies on the plane where the support is located.

9. The loudspeaker according to claim 7, wherein an orthographic projection of the sound-producing structure of one of the two vibration assemblies on a plane where the support is located does not fully overlap an orthographic projection of the sound-producing structure of the other one of the two vibration assemblies on the plane where the support is located.

10. The loudspeaker according to claim 7, wherein a length of a first sound-producing structure of one of the two vibration assemblies in the first direction is different a length of a first sound-producing structure of the other one of the two vibration assemblies in the first direction; and
a length of a second sound-producing structure of one of the two vibration assemblies in the first direction is different from a length of a length of a second sound-producing structure of the other one of the two vibration assemblies in the first direction.

11. The loudspeaker according to claim 7, wherein a vibration direction of a first sound-producing structure of one of the two vibration assemblies in the third direction is opposite to a vibration direction of a first sound-producing structure of the other one of the two vibration assemblies in the third direction;
a vibration direction of a second sound-producing structure of one of the two vibration assemblies in the third direction is opposite to a vibration direction of a second sound-producing structure of the other one of the two vibration assemblies in the third direction; and
the third direction is perpendicular to the first direction.

12. The loudspeaker according to claim 1, wherein the plurality of sound-producing structures all have a same cross-sectional shape; and/or, a sound-producing structure of the plurality of sound-producing structures has a rectangular, trapezoidal or triangular cross-section.

13. An electronic device, comprising a loudspeaker;
wherein the loudspeaker comprises:
a support, wherein the support is provided with a cavity extending through an upper surface of the support and a lower surface of the support;
a diaphragm assembly, wherein a periphery of the diaphragm assembly is fixedly connected to the support; and
a vibration assembly, wherein the vibration assembly is disposed on a side of the diaphragm assembly facing the support and is capable of driving the diaphragm assembly to vibrate in a third direction;
wherein the vibration assembly comprises a plurality of sound-producing structures, and the plurality of sound-producing structures are disposed in a same layer on the support;
the plurality of sound-producing structures comprise a first sound-producing structure and a second sound-producing structure;
the first sound-producing structure comprises a first free end and a first fixed end which are opposite to each other in a first direction, the first fixed end is connected to one end of the support, and the first free end is disposed on a side of the diaphragm assembly facing the cavity and is fixedly connected to the diaphragm assembly;
the second sound-producing structure comprises a second free end and a second fixed end which are opposite to each other in the first direction, the second fixed end is connected to the other end of the support, and the second free end is disposed on the side of the diaphragm assembly facing the cavity and is fixedly connected to the diaphragm assembly; and
the first direction is perpendicular to the third direction.

14. The electronic device according to claim 13, wherein the first sound-producing structure and the second sound-producing structure have a gap therebetween; an orthographic projection of the first sound-producing structure in a second direction and an orthographic projection of the second sound-producing structure in the second direction have an overlapping portion; and
any two of the first direction, the second direction or the third direction are perpendicular to each other.

15. The electronic device according to claim 14, wherein the first free end and the second free end are alternately disposed in the second direction; or
a plurality of first sound-producing structures and a plurality of second sound-producing structures are disposed, and at least two second free ends of at least two second sound-producing structures among the plurality of second sound-producing structures are disposed between two adjacent first free ends of two adjacent first sound-producing structures among the plurality of first sound-producing structures in the second direction; or
a plurality of first sound-producing structures and a plurality of second sound-producing structures are disposed, and at least two first free ends of at least two first sound-producing structures among the plurality of first sound-producing structures are disposed between two adjacent second free ends of two adjacent second sound-producing structures among the plurality of second sound-producing structures in the second direction.

16. The electronic device according to claim 13, wherein a vibration direction of the first sound-producing structure in the third direction is a same as a vibration direction of the second sound-producing structure in the third direction.

17. The electronic device according to claim 13, wherein the first free end and the second free end are each provided with a transmission member;
the transmission member of the first free end is disposed on a side of the first sound-producing structure facing away from the cavity, and a side of the transmission member of the first free end, facing away from the first free end, is connected to the diaphragm assembly;
the transmission member of the second free end is disposed on a side of the second sound-producing structure facing away from the cavity; and a side of the transmission member of the second free end, facing away from the second free end, is connected to the diaphragm assembly.

18. The electronic device according to claim 13, wherein two vibration assemblies are disposed;
a sound-producing structure of one of the two vibration assemblies is connected to a top surface of the support, and a portion of the sound-producing structure of the one of the two vibration assemblies is disposed above the cavity; and
a sound-producing structure of the other one of the two vibration assemblies is connected to a bottom surface of the support, and a portion of the sound-producing structure of the other one of the two vibration assemblies is disposed below the cavity.

19. The electronic device according to claim 18, wherein two diaphragm assemblies are disposed, the two diaphragm assemblies are in a one-to-one correspondence with the two vibration assemblies, and each of the two diaphragm assemblies is disposed on a side, facing away from the support, of a respective one of the two vibration assemblies.

20. The electronic device according to claim 19, wherein an orthographic projection of the sound-producing structure of one of the two vibration assemblies on a plane where the support is located fully overlaps an orthographic projection of the sound-producing structure of the other one of the two vibration assemblies on the plane where the support is located; or
wherein an orthographic projection of the sound-producing structure of one of the two vibration assemblies on a plane where the support is located does not fully overlap an orthographic projection of the sound-producing structure of the other one of the two vibration assemblies on the plane where the support is located.
